(19) United States
(12) Patent Application Publication
(10) Pub. No.: US 2007/0164060 A1
(43) Pub. Date: Jul. 19, 2007

(54) Powder dispenser

(76) Inventor: Geoffrey Denis Hayday, Kent (GB)

Correspondence Address: BARNES & THORNBURG LLP, P.O. BOX 2786, CHICAGO, IL, 60690-2786, US

(21) Appl. No.: 10/552,932

(22) PCT Filed: May 28, 2004
(86) PCT No.: PCT/GB04/02279

§ 371 Date: Oct. 17, 2006

(30) Foreign Application Priority Data
May 29, 2003 (GB) 0312254.6
Feb. 19, 2004 (GB) 0403650.5
Apr. 29, 2004 (GB) 0409516.2

(51) Int. Cl. B05B 11/06

(52) U.S. Cl. 222/633; 222/189.06; 239/327

(57) ABSTRACT

A powder container (110) and dispensing device comprising a powder dispensing nozzle (114) of the type having one or more small holes through which powder can be ejected. The nozzle (114) is located in the wall of a container (110) which in use is partially filled with the powder, and powder is dispensed therefrom by squeezing the container (110) to pressurize its contents. An intermediate powder reservoir is provided within the container (110) in or on which some of the powder within the container (110) becomes lodged in use. On squeezing the container, powder lodging in or on the intermediate reservoir is entrained in the airflow through the hole or holes in the nozzle to be discharged therewith. In general during each discharge action only powder in or on the intermediate reservoir will exit via the nozzle (114). The action of squeezing the container not only causes powder to leave the intermediate reservoir via the nozzle but also causes other of the powder in the container to replace the powder that has left the intermediate reservoir. In addition or alternatively replenishment is achieved by briefly squeezing, tilting or inverting or tilting and briefly squeezing the container. In this way the intermediate reservoir is replenished during or after each discharge ready to be discharged with the next squeeze of the container. The nozzle is provided at the end of a neck of the container, and the intermediate reservoir may comprise an apertured plate or a filter fitted in the neck of the container just below but spaced from the nozzle.

### FIELD OF INVENTION

This invention relates to devices for dispensing powder such as talcum powder.

### BACKGROUND

It is known to package talcum powder in a rigid container having a dispensing nozzle at one end having a plurality of small holes therein through which powder can be dispensed by shaking the container, normally in a horizontal or inverted condition.

It is also known to package talcum powder in a flexible walled container also having a similar dispensing nozzle at one end through which powder can be forced by squeezing the flexible wall, whether inverted or upright.

A powder dispenser is described in U.S. Pat. No. 4,730,751 in which a dip tube conveys powder to a discharge plug in a flexible walled container and a multicellular foam pad encases the lower end of the tube for effecting smooth and uniform movement, without clogging, of powder through the tube when the container is squeezed to discharge powder when the container is upright. The device includes air passages which allow air to pass directly to a mixing chamber in the plug and these can be covered by a similar foam pad to prevent clogging when discharging powder while the container is inverted.

### OBJECT OF THE INVENTION

It is an object of the present invention to provide a modification to such powder dispensing containers and nozzles therefore, to allow more controlled dispensing of powder therefrom.

### SUMMARY OF THE INVENTION

According to one aspect of the present invention within or associated with a powder dispensing nozzle of the type having one or more small holes through which powder can be ejected and located in the wall of a container partially filled with the powder which can be dispensed therefrom by squeezing the container to pressurise the contents, there. is provided an intermediate powder reservoir in or on which some of the powder within the container becomes lodged in use, such that on squeezing the container, at least some of the powder lodging in or on the intermediate reservoir is entrained in the air flow through the nozzle hole or holes, to be discharged therewith so that in general during each discharge action, only powder in or on the intermediate reservoir will exit via the nozzle.

The action of squeezing the container not only causes powder on or in the intermediate reservoir to leave the container via the hole or holes in the nozzle, but also causes other of the powder in the container to replace the powder that has left the intermediate reservoir, so that the latter is replenished during each discharge action and is left ready to discharge another quantity of powder via the nozzle with the next squeeze of the container.

In addition or alternatively the reservoir can be replenished by briefly tilting or inverting or gently squeezing or tilting and gently squeezing, or shaking the container.

In one embodiment the intermediate reservoir comprises a filter inserted in a neck of the container immediately below the nozzle.

In another embodiment the intermediate reservoir may be formed from two filters, one having smaller openings than the other, and the one filter is sandwiched between the nozzle and the other inner filter, each filter serving to hold a charge of powder and in use, during each discharge by squeezing, the powder on the intermediate filter is discharged through the nozzle openings, the charge on the inner filter transfers to the intermediate filter, and powder from within the container recharges the inner filter.

In another embodiment, the intermediate reservoir comprises a hollow tube one end of which comprises the nozzle and includes the hole or holes through which the powder exits, and the other end of which is closed, and a plurality of small holes are provided either in the wall of the tube or in the closed end thereof, or in both the wall and the end, through which powder can pass and in which powder can become lodged. The small holes and the interior of the tube form the intermediate reservoir.

The wall and/or closed end may be formed at least in part from a woven fabric, such as a woven wire or woven plastics mesh.

Where the wall of the tube is apertured, its area may be increased by corrugating the wall as in a vehicle oil or air filter.

Moulded plastics nodules or fingers may be formed on the exterior surface of the hollow tube, to further increase the surface area to which powder can adhere.

In a preferred embodiment no holes are formed in the wall of the tube but the inner closed end is formed with a plurality of apertures arranged in a rectilinear array or matrix and the thickness of the inner closed end is such that each aperture comprises a passage in which powder can become lodged. Typically the length of each passage is commensurate with or greater than its cross-section dimensions.

Preferably the passages taper in cross-section towards the nozzle opening(s) at the other end of the tube, so as to encourage clogging of the powder in the passages, during the charging of the intermediate reservoir formed thereby.

The nozzle may comprise two tubular sleeves which are relatively slidable, one of which constitutes the nozzle and has a closed end having a single nozzle exit passage therein and the other inner one of which has a closed end having a plurality of passages therethrough as aforesaid, in which powder will lodge and which form at least part of the intermediate reservoir, and internally a protrusion extends from the closed end of the inner sleeve which when the sleeves are pushed together enters and blocks the nozzle exit.

In a further embodiment the intermediate reservoir may comprise a wad of mesh of the type used to construct pan or paint scourers.

In another embodiment the intermediate reservoir may comprise a foam pad.

In a further embodiment the intermediate reservoir may comprise two foam pads, one having a coarser cell structure than the other and wherein the finer cell structure pad surrounds the other or is sandwiched between the nozzle and other the coarser cell structure pad, and powder is transferred from one to the other as the container is squeezed, powder from the finer cell structure pad being ejected via the nozzle openings while powder from the container simultaneously recharges the coarser cell structure pad.

The invention is of particular application to dispensers having a flexible resiliently deformable container wall and which are operated by squeezing the wall to force air and powder out through a nozzle, although as indicated earlier, the intermediate reservoir may also be charged by inverting and/or by shaking the container.

In another embodiment the intermediate reservoir may comprise a plurality of closely spaced apart elongate protrusions in the form of pins or filaments or fingers similar to the bristles of a brush, which protrude inwardly of the nozzle towards the interior of the container.

The protrusions may be of moulded plastics material and may be embedded at one end in a plastics plug forming part of the nozzle and having one or more holes therein through which the powder can exit.

Although usually relatively rigid the protrusions may be flexible and may possess a degree of resilience.

The number of protrusions making up the reservoir, determines the surface area available to entrap the powder. In general the larger the number the greater will be the capacity of the reservoir to retain powder in its structure.

Thus the purpose of the intermediate reservoir is threefold.

Firstly when for example squeezing so as to spray powder upwards, powder which is entrained in the reservoir will be discharged as a single dose upwards through the nozzle.

Secondly, without the reservoir, when held in an upright position, all the powder will occupy the lower part of the container, and often only a negligible amount will be entrained into the airflow through the nozzle created by the act of squeezing the container.

It is for this reason that a dip tube is used in prior art designs, but this is undesirable since it can become clogged. The intermediate reservoir therefore obviates the need for a dip tube.

The third purpose is to limit the quantity of powder discharged if the container is squeezed while in an inverted or partially inverted condition.

Hitherto in order to limit discharge rates, the openings in a nozzle of a container which it is intended to discharge downwardly are made very small, but such small openings in the nozzle can like a dip tube, easily become clogged if the container is squeezed while inverted or partially inverted. By restricting access to the nozzle and by trapping only some of the powder in the intermediate reservoir from which it can be dispensed, and thereby also restricting the rate at which powder can be discharged from the bulk of powder in the container, larger nozzle openings can be employed, thus reducing the risk of clogging. Without the intermediate reservoir, excessive amounts of powder could be discharged if the nozzle openings were of such a size so as to reduce the risk of clogging.

Thus the use of an intermediate reservoir facilitates upward discharge, and can prevent nozzle clogging or excessive powder discharge, when discharging downwards by squeezing the container.

According to another aspect of the present invention a method of discharging powder such as talcum powder, from a flexible walled container having at one end an outlet nozzle containing at least one small opening, and an intermediate reservoir between the nozzle and the interior of the container in which powder can be retained for subsequent discharge through the nozzles, comprises the steps of squeezing or tilting or inverting the container to charge the intermediate reservoir, and thereafter squeezing the container to pressurise the contents of the container and force powder in the intermediate reservoir through the nozzle, and simultaneously to replenish powder in the intermediate reservoir.

If the preferred discharge direction is upwards, the container is rotated into an upright or near upright condition prior to squeezing so that excess powder not retained in the intermediate reservoir falls away therefrom, back into the container so as not to be available to be discharged.

The container wall is preferably resiliently deformable and reverts to its normal shape when the squeezing force is removed.

The invention will now be described by way of example with reference to the accompanying drawings in which:

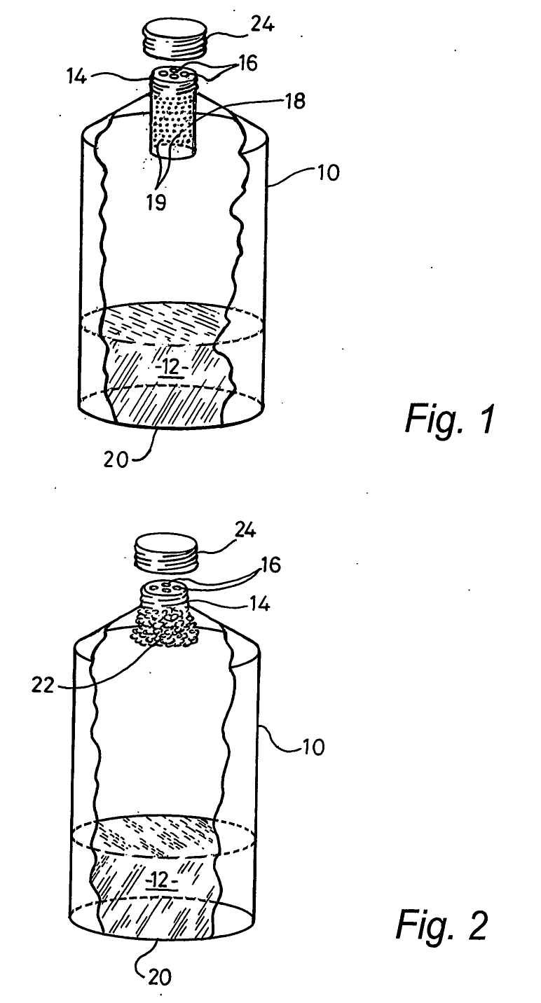

FIG. 1 is a cut away section through a powder container fitted with a tubular intermediate powder reservoir,

FIG. 2 is a cut away section through a powder container fitted with a mesh which comprises an intermediate powder reservoir,

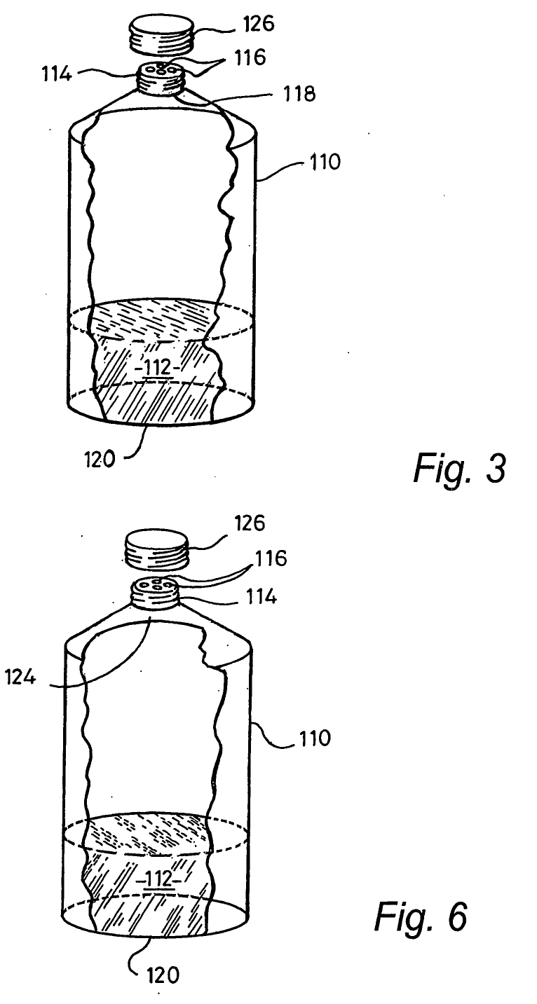

FIG. 3 is a cut away section through a powder container fitted with a tubular intermediate powder reservoir below the discharge nozzle,

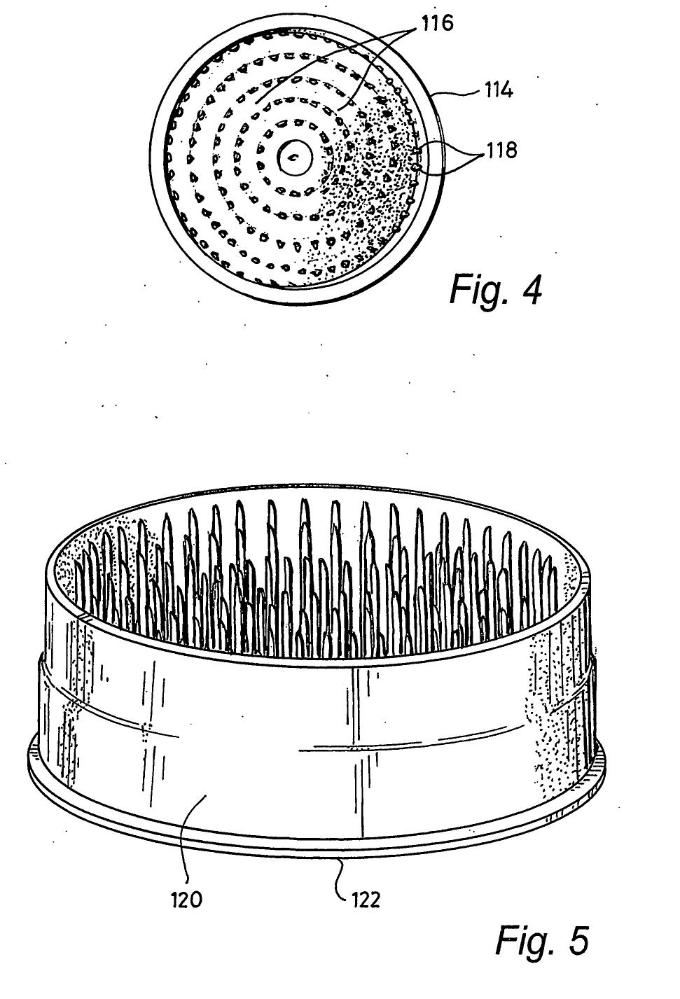

FIG. 4 is a plan view of a nozzle reservoir and employed in the container of FIG. 3,

FIG. 5 is a perspective front elevation of the nozzle reservoir of FIG. 4,

FIG. 6 is a cut away section through a powder container fitted with another tubular intermediate powder reservoir in which a mesh of plastics material is fitted within the tube,

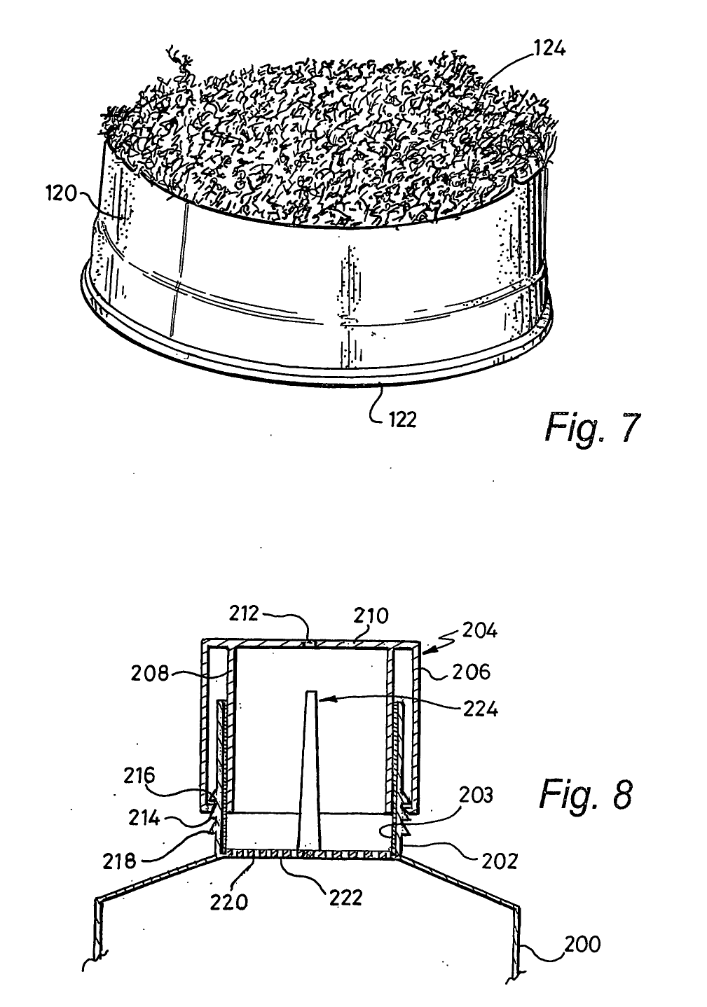

FIG. 7 is a perspective front elevation of the nozzle reservoir of FIG. 6,

FIG. 8 is a side elevation in cross-section through a nozzle and intermediate reservoir constructed as a preferred embodiment of the invention,

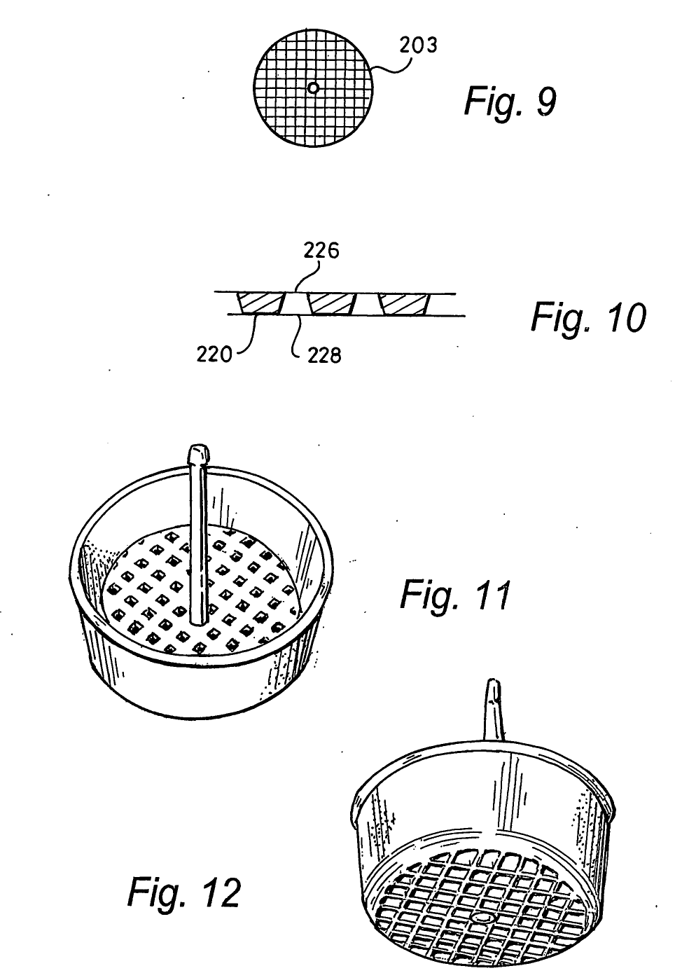

FIG. 9 is a plan view of the lower end of the tubular assembly of FIG. 8,

FIG. 10 is a cross-section through the lower end of FIG. 9 to an enlarged scale,

FIG. 11 is a perspective view from above showing the interior of the inner tubular member of the nozzle assembly of FIG. 8, and

FIG. 12 is a perspective view thereof from below.

The invention provides a chamber in the discharge nozzle of the powder container which allows a dispenser to be made without the need for a dip tube to convey powder to the nozzle when discharge is to be effected by squeezing the wall of the container when in an upright condition.

The chamber may be a defined compartment or may be formed from a plurality of protrusions like the bristles of a brush or arranged like a comb which is coiled into a spiral or into a helix, with the bristle-like protrusions or prongs of the comb pointing toward the region of the container in which the main charge of powder is stored. The protrusions or prongs each constitute a surface onto which powder will adhere when the reservoir is “charged”, and the structure allows for free flow of air from the inside of the container through the nozzle openings in a plug or base from which the protrusions or prongs extend. Airflow is established when the container wall is squeezed, the air flow serving to entrain some or all of the powder clinging to the protrusions or prongs.

In FIG. 1 a powder container 10 containing a main charge of powder such as talcum powder 12 is provided at its upper end with a dispensing nozzle 14 the upper end of which includes four holes 16 through which powder can be discharged. This is achieved by squeezing or inverting and/or shaking the container 10. Thus if the wall of the container is resiliently deformable, as by being made from a plastics material, the powder can be discharged upwardly or downwardly by squeezing the wall of the container, so as to force air and powder entrained therein, through the openings 16. If the container wall is not squeezed, discharge can still be obtained by shaking the container in its inverted condition.

In accordance with the invention an intermediate powder reservoir is provided below the nozzle 14. In FIG. 1 this comprises a hollow tubular member 18 fitted below the nozzle 14 so as to protrude inside the container. The wall of 18 includes a large number of small holes 19. Powder can become lodged in these holes if the container is squeezed, shaken or inverted, and some powder may pass through the holes into the interior of the tube 18. Whether inside or merely lodged in the holes 19 in the wall of the tube, the latter serves as a reservoir for powder. When the container is subsequently shaken or squeezed the powder inside the tubular reservoir (or merely in the holes 19) will be forced through the nozzle holes 16.

Where it is not intended that the powder is to be discharged by squeezing the wall of the container, the holes 19 in the wall of the tubular reservoir 18 are preferably larger than if the powder is to be discharged under pressure, so that the act of inverting the container will cause powder to enter the reservoir 18, through the holes, and the act of subsequently shaking the container will cause the powder in 18 to exit by the holes 16.

The base 20 of the tubular reservoir 18 may be solid so that once powder has entered 18 through holes 19 there is little tendency for it to drop back into the main charge of powder in 10, under gravity, once the container has been stood upright on its base 20.

Alternately the base 20 may be formed with openings as well as, or instead of, the cylindrical wall.

The cylindrical wall and/or the base 20 of the reservoir 18 may be formed from a woven fabric-like material such as woven wire mesh, the openings in the fabric or mesh comprising the holes such as 19, or from a solid material (metal or plastics) which is perforated by small holes such as 19.

The wall or base (or both) of the intermediate reservoir may be constructed from a perforated foil such as is employed in electric razors, where it is found that the powder becomes lodged in the openings, and may penetrate into the interior of the container formed by the foil, for subsequent dislodgement and exit via the nozzle openings.

Preferably the foil is much thicker than that used in a razor so that the openings are more like passages, in which the powder can become lodged.

Thus where the reservoir comprises a container the wall or base (or both) of which is perforated with slightly larger holes, the thickness of the container wall or base may be at least equal to (and preferably is twice or three times) the diameter of the holes such as 19, in the reservoir wall or base, in order to reduce the chance of powder leaving the reservoir 18 and falling back into the main charge of powder 12.

Where the larger holes are openings in a thinner wall, a hollow tubular protrusion (not shown) may surround each hole and extend internally of the reservoir 18 so as to make it less likely for powder particles inside the reservoir to leave via the holes such as 19, and to create passages within which the powder can reside.

Where holes are formed in the base 20 of the reservoir 18 and an upstanding tubular protrusion is provided for each hole, this will prevent powder which has built up in the base of the reservoir 18 from falling out through the holes in the base 20 at least until the depth of powder is greater than the internal height of the protrusions.

An alternative design of reservoir is shown in FIG. 2, where items which are similar to those shown in FIG. 1 are denoted by the same reference numerals.

Here item 18 is replaced by a wad of plastic mesh 22 similar to a pan scourer. The act of shaking or inverting the container 10 will cause powder to become trapped in the mesh for subsequent discharge, either with continued shaking or if the container wall is flexible and the wall is squeezed to pressurise the interior of the container.

Where the act of shaking the container to charge the reservoir such as 18 or 22 results in some of the powder escaping prematurely, the openings 16 may be covered with the hand or with a cap such as 24, which is removed before the container is subsequently shaken or squeezed to discharge the powder trapped in the reservoir, through the holes 16.

Although four holes 16 are shown, it is to be understood that irrespective of the design of the intermediate reservoir any number of holes can be employed, either more or less, and a nozzle having only one hole can be used.

Although not shown where the reservoir 18 is moulded from plastics material, spikes or hairs which may be integrally formed by moulding from plastics material, may be formed on the surface of the reservoir (both inside and/or outside) to increase the surface area available to which powder can adhere. In addition or alternatively the outer surface may include a grid or gauze or honeycomb-like structure, defining a plurality of openings (pigeon holes) in which powder can become trapped when the container is squeezed or shaken or inverted. When the container is subsequently shaken (or where the container wall is flexible, the container is squeezed) the powder trapped in or on the reservoir 18 is discharged through the nozzles, and other powder from within the container is taken up by the reservoir 18 ready to be discharged through the nozzle when the container is shaken or squeezed again.

The tubular reservoir 18 of FIG. 1 may be replaced by a cylindrical pad of open cell foamed plastics material, and shaking the container (or squeezing the container wall where it is flexible) will cause powder to enter the cellular structure of the foamed material, such that subsequent shaking (or pressurisation of the container by squeezing the wall thereof) will result in the powder clinging to the cell structure to be forced out through the nozzle openings, and to be replaced by other powder from within the container ready for discharge during the next shake of the container or squeeze of the container wall.

The cylindrical pad of open cell foamed plastics material may be solid or hollow.

Two pads of open cell foamed plastics material may be provided in place of a single pad, the one nearer to the nozzle openings having smaller cell structure than the other, which is separated from the nozzle openings by the foam pad having the smaller cell structure.

In FIG. 3 a powder container 110 containing a main charge of powder such as talcum powder 112 is provided at its upper end with a dispensing nozzle 114 the upper end of which includes four holes 116 through which powder can be discharged. This is achieved by squeezing the wall of the container, so as to force air and powder entrained therein, through the openings 116.

An intermediate powder reservoir is provided in the nozzle 114 in the form of a large number of elongate protrusions in the form of pins or filaments or fingers 118 which extend from the upper end of the nozzle so as to protrude into the container. If the container is shaken or inverted or squeezed, powder can become lodged on these protrusions 118 and the latter serve as a reservoir for powder. When the contents of the container are subsequently pressurised by squeezing the container wall air, will be forced out through the holes 116, and in passing through the protrusions 118, powder clinging thereto will become entrained in the airflow and will exit via the holes 116. A preferred form of reservoir is shown in FIGS. 4 and 5, and comprises a cylindrical plastics shell 120 having one end open through which the protrusions 118 can protrude and closed at the other end by a cap 122 formed with exit holes 116.

The protrusions 118 are typically moulded at the same time as the shell 120 is moulded, and whilst normally will be relatively rigid, need not be so, and may be flexible and may possess a degree of resilience.

The reservoir pins 118 may be arranged randomly or in a regular pattern and for example may be arranged along a spiral or helical path or in a series of spaced apart concentric rings.

An alternative design of reservoir is show in FIGS. 6 and 7, where items which are similar to those shown in FIG. 3 are denoted by the same reference numerals.

Here the pins 118 are replaced by a wad of plastics mesh 124 similar to a pan scourer. The act of shaking or inverting or squeezing container 110 will cause powder to become trapped in the mesh, for subsequent discharge, when the container wall is squeezed to pressurise the interior of the container, and force air out through the nozzle openings 116, which on passing through the mesh, entrains some of the powder clinging to the mesh.

The alternative intermediate reservoir is best seen in FIG. 7.

Although four holes 116 are shown in the nozzle end it is to be understood that irrespective of the design of the intermediate reservoir any number of holes can be employed, and a nozzle having only one hole can be used.

A cap 126 may be provided to prevent unwanted discharge of powder from the container. The cap may be a simple push-fit, or the nozzle and cap may be formed with a complementary screw thread.

FIGS. 8 to 12 illustrate a preferred construction of nozzle and intermediate reservoir. Here the upper end of a squeezable powder container is denoted 200. This terminates in a cylindrical tube 202 onto and into which is fitted a cylindrical closure cap 204. The latter includes an outer sleeve 206 and an inner concentric sleeve 208, radially spaced from the outer sleeve to form an annular cavity, within which the tube 202 is received.

The upper end of the closure 204 is closed by an end 210 containing a central powder discharge exit 112.

At its other end the outer sleeve 206 includes a radially inwardly directed lip 214 which is a snap fit over a complementary radially directed ridge 216. At least the ridge is formed from material having a natural resilience so that it can be forced over the ridge 216. However by constructing the ridge and the lip so as to form a so-called fir-tree connection, once the closure has been forced of the ridge 216, it will be held captive on the tube 202.

A second similar fit-tree type ridge is also provided around the tube 202 at 218. The closure cap 204 can be forced over this second ridge in a similar way to the upper ridge 216 by virtue of the resilience of the material forming the ridge and/or the lip and/or the cap and/or the tube. Both ridge 216 and 218 are continuous, but according to a preferred feature of this embodiment of the invention, the lip 214 may be cut away except for two diametrically opposite regions. By making the well of the cap 204 from resiliently deformable plastics, the cap closure 204 can be pushed down to snap fit over the ridge 216 and due to the fir tree nature of the connection between 214, 218 it will be retained in that position. However it can only be pulled up to occupy the intermediate position shown in FIG. 8 if the cap closure 204 is first squeezed orthogonally to the two regions of the lip 214 so that the cap is deformed sufficiently to allow the two regions of the lip 214 to pass the ridge 216.

The tube 202 is fitted internally with a cylindrical cup 203 the lower end of which is closed by a base 220 which includes a plurality of passages such as 222 therethrough into or through which powder can pass. The intermediate reservoir is formed by the cylindrical wall of cup 203 and its apertured base 220.

Within the cup 203, and upstanding centrally from the base 220, is a spike 224 which is aligned with the exit opening 212 in the closed end 210 of cap 204.

The spike 224 preferably tapers to facilitate its entry into 212.

The cup 203 may be an interference fit in the tube 202 or may be additionally secured in place.

The dimensions of the wall of tube 202, the positions of the ridges 216, 218 and the length of the spike 224 are selected so that when the closure cap 204 is positioned as shown in FIG. 8, the spike is clear of the exit 212, but when the cap 204 has been pushed down and is held captive by the lower ridge 218, the spike enters and closes off the exit 212.

The inside surface of the wall of the cap 203 preferably makes a powder-tight seal with the outer surface of the sleeve 208. This prevents powder loss between the wall 202 and wall 206 when the container is squeezed and the contents are momentarily pressurised. Discharge of powder lodged in the openings such as 222 and from within the cap 203 is achieved by entraining the powder in the airflow through the exit 212, in manner know per se. The movement of air within the body of the container also entrains powder and this lodges in the passages 222 in place of the powder dislodged therefrom and discharged through the exit 212.

FIG. 9 shows how the base 220 or cup 203 may be formed with a rectilinear array of square openings each corresponding to 222 in FIG. 8.

As shown to an enlarged scale in FIG. 10, each opening preferably tapers so that the area of the opening 226 in the upper face of base 220 is smaller than the area of the opening 220 at the other end of the passage in the lower face of base 220.

FIGS. 11 and 12 are perspective views of the cylindrical cup 203 which when fitted in 202 forms the intermediate reservoir of FIG. 8.

The container may comprise a plastic powder puffer dispenser.

Although not shown, a removable cap may be provided for fitting over the nozzle to prevent loss of powder through the nozzle exit opening.

Where such a cap is provided or the nozzle and intermediate reservoir assembly allows for movement of one part relative to another to close the nozzle exit opening, the latter may be closed prior to shaking, squeezing, inverting or tilting the container to charge or recharge the intermediate reservoir.

In practice it has been found preferable to use a more gentle squeeze of the container wall when charging or recharging the intermediate reservoir, than the rather firmer, more vigorous squeeze which is preferred to achieve discharge of powder through the nozzle.

1-29. (canceled)

30. A powder container and dispensing device comprising a container which in use is partially filled with the powder and includes a neck, a powder dispensing nozzle provided in the wall of the container at the outer end of the container neck, the nozzle being of the type having one or more small holes through which powder can be ejected, the powder being dispensable by squeezing the container to pressurize its contents, and an intermediate powder reservoir in or on which some of the powder within the container becomes lodged in use, wherein the intermediate reservoir comprises a cup which is fitted within the neck with the closed end of the cup spaced from the nozzle, and the closed end of the cup includes a plurality of small holes therein to allow powder to enter the interior of the cup and in which powder can become lodged, such that on squeezing the container, powder lodging in or on the intermediate reservoir is entrained in the airflow through the hole or holes in the nozzle to be discharged therewith, so that in general during each discharge action only powder in or on the intermediate reservoir will exit via the nozzle.

31. A device as claimed in claim 30 wherein the action of squeezing the container in use also causes other of the powder in the container to replace powder that has left the intermediate reservoir, so that the latter is replenished by each squeeze ready to be discharged with the next squeeze, or the replenishment is achieved by gently squeezing, tilting, inverting or tilting and gently squeezing the container prior to squeezing the container to discharge powder through the nozzle.

32. A device as claimed in claim 30, wherein the intermediate reservoir comprises an apertured plate or a filter fitted in the neck of the container just below but spaced from the nozzle.

33. A device as claimed in claim 32, wherein the filter or plate is formed from a woven fabric such as woven wire or a woven plastics mesh.

34. A device as claimed in claim 30, wherein the intermediate reservoir comprises two apertured plates or filters fitted within the neck, a first having smaller openings than the second in which the first is sandwiched between the nozzle and the second and each serves to hold a charge of powder, and when the container is squeezed the charge of powder in the first plate or filter is discharged through the nozzle openings, the charge of powder in the second plate or filter is transferred to the first filter, and the second plate or filter is recharged with powder from within the container.

35. A device as claimed in claim 34, wherein each filter or plate is formed from a woven fabric such as woven wire or a woven plastics mesh.

36. A device as claimed in claim 30, wherein the nozzle is formed by a second cup which fits over and around the neck, the closed end of the second cup including one exit aperture through which powder is discharged when the container is squeezed.

37. A device as claimed in claim 36, wherein the second cup is slidable relative to the neck and an elongate protrusion extends from the closed end of the first cup towards the closed end of the second cup in alignment with the exit aperture in the closed end of the second cup, the movement of the second cup relative to the neck enabling the exit aperture to be positioned clear of the end of the protrusion to permit powder to exit, but also enabling the second cup to be moved so that the end of the protrusion enters and closes off the exit aperture to prevent powder from leaving.

38. A device as claimed in claim 37, wherein the neck is cylindrical and the second cup includes an inner concentric cylindrical wall which is a sliding fit within the neck, or within the first cup fitted within the neck.

39. A device as claimed in claim 37, wherein the second cup is a snap fit around a radial protrusion from the wall of the neck to prevent the cup from being pulled completely off the neck.

40. A device as claimed in claim 30, wherein the holes in the intermediate reservoir are arranged in a rectilinear array or matrix.

41. A device as claimed in claim 30, wherein the cross-section of each hole in the cup tapers from the end adjacent the interior of the container to the end adjacent the nozzle.

42. A device as claimed in claim 30, wherein the container wall is resiliently deformable by squeezing and will in general revert to its normal shape when the squeezing force is removed.

43. A method of discharging powder from a powder container and dispensing device as claimed in claim 1, comprising the steps of gently squeezing, tilting, inverting or tilting and gently squeezing the container to charge the intermediate reservoir, and thereafter squeezing the flexible container wall to again pressurise the contents of the container and force powder in the intermediate reservoir through the nozzle, and simultaneously to recharge the intermediate reservoir with a fresh charge of powder.

44. A method as claimed in claim 43, wherein prior to squeezing the container to dislodge powder, it is rotated into an upright or near upright condition so that powder not retained in or on the intermediate reservoir falls away from the discharge end of the container so as not to be available to be discharged.

45. A method as claimed in claim 43, wherein the nozzle opening is covered or blocks temporarily while the intermediate reservoir is charged or recharged with powder.

46. A method as claimed in claim 43, wherein the powder is talcum powder.
